(19) United States
(12) Patent Application Publication
(10) Pub. No.: US 2004/0107102 A1
(43) Pub. Date: Jun. 3, 2004

(54) Text-to-speech conversion system and method having function of providing additional information

(75) Inventors: Seung-Nyang Chung, Seoul (KR); Jeong-Mi Cho, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/704,597

(22) Filed: Nov. 12, 2003

(30) Foreign Application Priority Data
Nov. 15, 2002 (KR) 10-2002-0071306

(51) Int. Cl. G10L 13/00

(52) U.S. Cl. 704/260

(57) ABSTRACT

The present invention relates to a text-to-speech conversion system and method having a function of providing additional information. An object of the present invention is to provide a user with words, as the additional information, that are expected to be difficult for the user to recognize or belong to specific parts of speech among synthesized sounds output from the text-to-speech conversion system. The object can be achieved by providing the method of selecting emphasis words from an input text by using language analysis data and speech synthesis result analysis data obtained from the text-to-speech conversion system and of structuring the selected emphasis words in accordance with sentence pattern information on the input text and a predetermined layout format.

### CLAIM OF PRIORITY

This application makes reference to and claims all benefits accruing under 35 U.S.C. '119 from my application TEXT-TO-SPEECH CONVERSION APPARATUS AND METHOD HAVING FUNCTION OF OFFERING ADDITIONAL INFORMATION filed with the Korean Industrial Property Office on Nov. 15, 2002 and with Serial No. 71306/2002, which application is hereby expressly incorporated herein by reference.

### BACKGROUND OF THE INVENTION

1. Field of the Invention

The present invention relates to a text-to-speech conversion system and method having a function of providing additional information, and more particularly, to a text-to-speech conversion system and method having a function of providing additional information, wherein a user is provided with words as the additional information, which belong to specific parts of speech or are expected to be difficult for the user to recognize in an input text, by using language analysis data and speech synthesis result analysis data that are obtained in processes of language analysis and speech synthesis of a text-to-speech conversion system (hereinafter, referred to as “TTS”) that converts text to speech.

2. Description of the Related Art

In speech synthesis technology, when a text is input, the text is converted into natural, synthesized sounds which in turn are output through procedures of language analysis of the input text and synthesis thereof into speech, which are performed by the TTS.

Referring to FIG. 1, a schematic configuration and processing procedure of a general TTS will be explained through a system that synthesizes Korean text into speech.

First, a preprocessing unit 2 performs a preprocessing procedure of analyzing an input text by using a dictionary type of numeral/abbreviation/symbol DB 1 and then changing characters other than Korean characters into relevant Korean characters. The morpheme analysis unit analyzes morphemes of the preprocessed sentence by using a dictionary type of morpheme DB 3, and divides the sentence into parts of speech such as noun, adjective, adverb and particle in accordance with the morphemes.

A syntactic analysis unit 5 analyzes the syntax of the input sentence. A character/phoneme conversion unit 7 converts the characters of the analyzed syntax into phonemes by using a dictionary type of exceptional pronunciation DB 6 that stores pronunciation rule data on symbols or special characters.

A speech synthesis data-generating unit 8 generates a rhythm for the phoneme converted in the character/phoneme converting unit 7; synthesis units; boundary information on characters, words and sentences; and duration information on each piece of speech data. A basic frequency-controlling unit 10 sets and controls a basic frequency of the speech to be synthesized.

Further, a synthesized sound generating unit 11 performs the speech synthesis by referring to a speech synthesis unit, which is obtained from a synthesis unit DB 12 storing various synthesized sound data, speech synthesis data generated through the above components, the duration information, and the basic frequency.

The object of this TTS is to allow a user to easily recognize the provided text information from the synthesized sounds. Meanwhile, the speech has a time restriction in that it is difficult to again confirm a speech, which has already been output, since speech information goes away as time passes. In addition, there is inconvenience in that in order to recognize information provided in the form of synthesized sounds, the user must continuously pay attention to the output synthesized sounds, and always try to understand the contents of the synthesized sounds.

Meanwhile, although there have been attempts to generate natural, synthesized sounds close to an input text by using character recognition and synthesis data in the form of a database, the text-to-speech synthesis is not yet perfect. Thus, the user cannot recognize or misunderstands the information provided by the TTS.

Therefore, there is a need for a supplementary means of smooth communication through synthesized sounds provided by a TTS.

In order to solve the problems of the prior art, Korean Patent Laid-Open Publication No. 2002-0011691 entitled “Graphic representation method of conversation contents and apparatus thereof” discloses a system capable of improving the efficiency of conversation by extracting intentional objects included in the conversation from a graphic database and outputting the motions, positions, status and the like of the extracted intentional objects onto a screen.

In this system, there is inconvenience in that a huge graphic database is required to express words corresponding to a plurality of intentional objects that are used in daily life, and graphic information corresponding to each word pertinent to one of the intentional objects must be searched for and retrieved from the graphic database.

Further, Japanese Patent Laid-Open Publication No. 1995-334507 (entitled “Human body action and speech generation system from text”) and Japanese Patent Laid-Open Publication No. 1999-272383 (entitled “Method and device for generating action synchronized type speech language expression and storage medium storing action synchronized type speech language expression generating program”) disclose a method in which words for indicating motions are extracted from a text and motion video is output together with synthesized sounds, or the motion video accompanied with the synthesized sounds are output when character strings accompanying motions are detected from speech language.

However, even in these methods, there is inconvenience in that a huge database storing the motion video that shows the motion for each text or character string should be provided, and whenever each text or character string is detected, the relevant motion video should be searched for and retrieved from the database.

Furthermore, Korean Patent Laid-Open Publication No. 2001-2739 (entitled “Automatic caption inserting apparatus and method using speech recognition equipment”) discloses a system wherein caption data are generated by recognizing speech signals that are reproduced/output from a soundtrack of a program, and the caption data are caused to be coincident with the original output timing of the speech signals, and then to be output.

However, since this system displays only the caption data on the speech signals that are reproduced/output from the soundtrack, it is not a means capable of allowing the user to more efficiently understand and recognize the provided information.

### SUMMARY

The present invention is contemplated to solve the aforementioned problems. An object of the present invention is to enable smooth communication through a TTS by providing words, which belong to specific parts of speech or are expected to be difficult for a user to recognize, as emphasis words by using language analysis data and speech synthesis result analysis data that are obtained in the process of language analysis and speech synthesis of the TTS.

Another object of the present invention is to improve the reliability of the TTS through the enhancement of information delivery capabilities by providing structurally arranged emphasis words together with synthesized sounds to allow the user to intuitionally recognize the contents of the information through the structurally expressed emphasis words.

In order to achieve the objects, a text-to-speech conversion system having a function of providing additional information according to one embodiment of the present invention comprises a speech synthesis module for analyzing text data in accordance with morphemes and a syntactic structure, synthesizing the text data into speech by using obtained speech synthesis analysis data, and outputting synthesized sounds; an emphasis word selection module for selecting words belonging to specific parts of speech as emphasis words from the text data by using the speech synthesis analysis data obtained from the speech synthesis module; and a display module for displaying the selected emphasis words in synchronization with the synthesized sounds.

In another embodiment of the present invention, a text-to-speech conversion system having a function of providing additional information comprises an information type-determining module for determining information type of the text data by using the speech synthesis analysis data obtained from the speech synthesis module, and generating sentence pattern information; and a display module for rearranging the selected emphasis words in accordance with the generated sentence pattern information and displaying the rearranged emphasis words in synchronization with the synthesized sounds.

In a further embodiment of the present invention, the text-to-speech conversion system further comprises a structuring module for structuring the selected emphasis words in accordance with a predetermined layout format.

In addition, the emphasis words further include words, which have matching ratios less than a predetermined threshold value and are expected to be difficult for the user to recognize due to distortion of the synthesized sounds among words of the text data, by using the speech synthesis analysis data obtained from the speech synthesis module, and are selected as words of which emphasis frequencies are less than a predetermined threshold value among the selected emphasis words.

Further, in order to achieve the objects, a text-to-speech conversion method having a function of providing additional information according to one embodiment of the present invention comprises a speech synthesis step for analyzing text data in accordance with morphemes and a syntactic structure, synthesizing the text data into speech by using obtained speech synthesis analysis data, and outputting synthesized sounds; an emphasis word selection step for selecting words belonging to specific parts of speech as emphasis words from the text data by using the speech synthesis analysis data; and a display step for displaying the selected emphasis words in synchronization with the synthesized sounds.

In another embodiment of the present invention, a text-to-speech conversion method having a function of providing additional information a sentence pattern information-generating step for determining information type of the text data by using the speech synthesis analysis data obtained from the speech synthesis step, and generating sentence pattern information; and a display step for rearranging the selected emphasis words in accordance with the generated sentence pattern information and displaying the rearranged emphasis words in synchronization with the synthesized sounds.

In a further embodiment of the present invention, the text-to-speech conversion method further comprises a structuring step for structuring the selected emphasis words in accordance with a predetermined layout format.

In addition, the emphasis words further includes words, which have matching ratios less than the predetermined threshold value and are expected to be difficult for the user to recognize due to the distortion of the synthesized sounds, by using the speech synthesis analysis data, and are selected as words of which emphasis frequencies are less than a predetermined threshold value among the selected emphasis words.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram schematically showing a configuration and operational process of a conventional TTS;

FIG. 2 is a block diagram schematically illustrating a configuration of a text-to-speech conversion system having a function of providing additional information according to the present invention;

FIG. 3 is a flowchart illustrating an operational process of a text-to-speech conversion method having a function of providing additional information according to an embodiment of the present invention;

FIG. 4 is a flowchart illustrating step S30 shown in FIG. 3;

FIG. 5 is a flowchart illustrating an operational process of a text-to-speech conversion method having a function of providing additional information according to another embodiment of the present invention;

FIG. 6 is a flowchart illustrating step S300 shown in FIG. 5;

FIG. 7 is a flowchart illustrating step S500 shown in FIG. 4;

FIG. 8 is a view illustrating a calculation result of a matching rate according to another embodiment of the present invention; and

FIGS. 9a to 9c are views showing final additional information according to respective embodiments of the present invention.

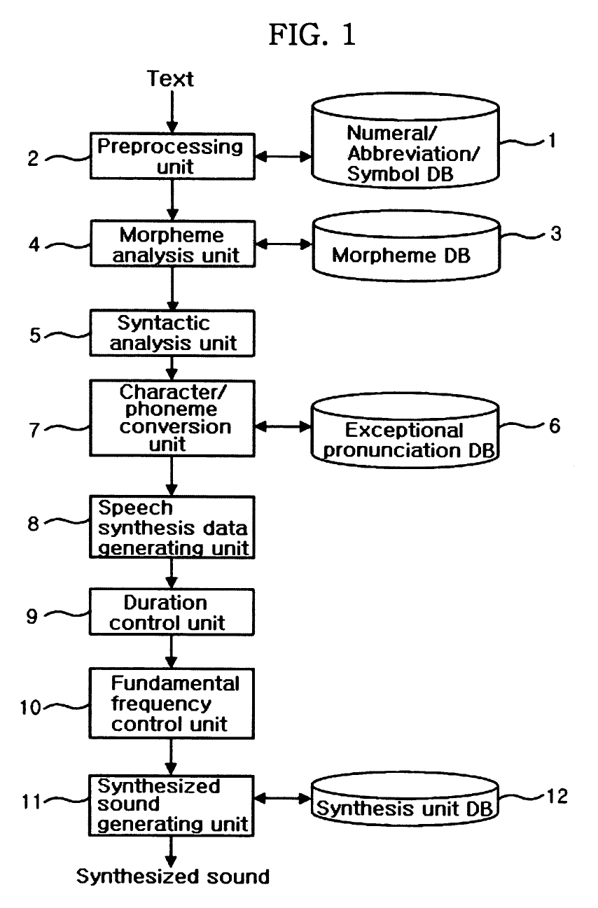

### DESCRIPTION

Hereinafter, a configuration and operation of a text-to-speech conversion system having a function of providing additional information according to the present invention will be described in detail with reference to the accompanying drawings.

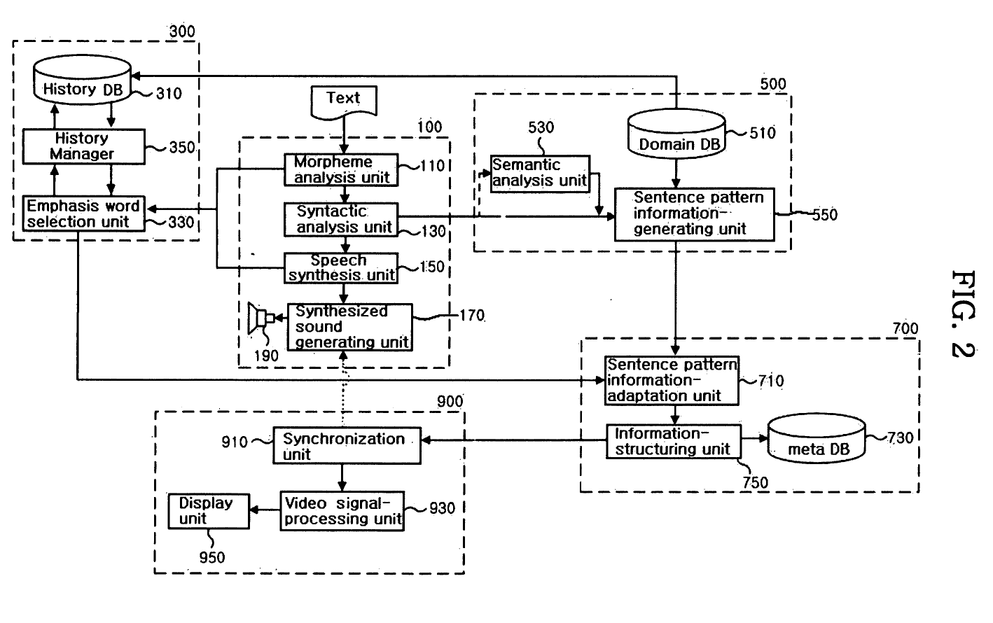

Referring to FIG. 2, the text-to-speech conversion system according to an embodiment of the present invention mainly comprises a speech synthesis module 100, an emphasis word selection module 300, and a display module 900. Another embodiment of the present invention further includes an information type-determining module 500 and a structuring module 700.

Although a history DB 310, a domain DB 510 and a meta DB 730 shown in FIG. 2, which are included in the modules, are constructed in a database (not shown) provided in an additional information generating apparatus according to the present invention, they are separately shown for the detailed description of the present invention.

The speech synthesis module 100 analyzes text data based on morpheme and syntax, synthesizes the input text data into sounds by referring to language analysis data and speech synthesis result analysis data obtained through the analysis of the text data, and outputs the synthesized sounds. The speech synthesis module 100 includes a morpheme analysis unit 100, a syntactic analysis unit 130, a speech synthesis unit 150, a synthesized sound generating unit 170, and a speaker SP 190.

The morpheme analysis unit 110 analyzes the morphemes of the input text data and determines parts of speech (for example, noun, pronoun, particle, affix, exclamation, adjective, adverb, and the like) in accordance with the morphemes. The syntactic analysis unit 130 analyzes the syntax of the input text data.

The speech synthesis unit 150 performs text-to-speech synthesis using the language analysis data obtained through the morpheme and syntactic analysis processes by the morpheme analysis unit 110 and the syntactic analysis unit 130, and selects synthesized sound data corresponding to respective phonemes from the synthesis unit DB 12 and combines them.

During the process in which the speech synthesis unit 150 combines the respective phonemes, timing information on the respective phonemes is generated. A timetable for each phoneme is generated based on this timing information. Therefore, the speech synthesis module 100 can know in advance which phoneme will be uttered after a certain period of time (generally, on the basis of 1/1000 sec) passes from a starting point of the speech synthesis through the generated timetable.

That is, by informing a starting point of the utterance and simultaneously operating a timer when outputting the synthesized sounds through the speech synthesis module 100, other modules can estimate a moment when a specific word is uttered through the timing information provided upon utterance of the specific word (combination of phonemes).

The synthesized sound generating unit 170 processes the speech synthesis result analysis data obtained from the speech synthesis unit 150 so as to output through the speaker 190, and outputs them in the form of synthesized sounds.

Hereinafter, the language analysis data that includes the morpheme and syntactic analysis data obtained during the morpheme and syntactic analysis processes by the morpheme analysis unit 110 and the syntactic analysis unit 130, and the speech synthesis result analysis data that are composed of the synthesized sounds obtained during the speech synthesis process of the speech synthesis unit 150 will be defined as the speech synthesis analysis data.

The emphasis word selection module 300 selects emphasis words (for example, key words) from the input text data by using the speech synthesis analysis data obtained from the speech synthesis module 100, and includes a history DB 310, an emphasis word selection unit 330 and a history manager 350 as shown in FIG. 2.

The history DB 310 stores information on emphasis frequencies of words that are frequently used or emphasized among the input text data obtained from the speech synthesis module 100.

In addition, it stores information on emphasis frequencies of words that are frequently used or emphasized in the field of information type corresponding to the input text data.

The emphasis word selection unit 330 extracts words, which belong to specific parts of speech or are expected to have distortion of the synthesized sounds (i.e., have matching rates each of which is calculated from a difference between an output value expected as a synthesized sound and an actual output value), as emphasis words by using the speech synthesis analysis data obtained from the speech synthesis module 100. In addition, the emphasis words are selected by referring to words that are unnecessary to be emphasized and selected by the history manager 350.

The specific parts of speech are predetermined parts of speech designated for selecting the emphasis words. If the parts of speech selected as the emphasis words are, for example, a proper noun, loanword, a numeral and the like, the emphasis word selection unit 330 extracts words corresponding to the designated parts of speech from respective words that are divided based on morpheme by using the speech synthesis data.

Further, the synthesized sound matching rate is determined by averaging matching rates of speech segments by using the following equation 1. It is expected that the distortion of the synthesized sound may occur if a mean value of the matching rates is lower than a predetermined threshold value and is expected that the distortion of the synthesized sound may little occur if not.

ΣQ(size of (Entry), |estimate value−actual value|, C)/N (1)

where C=matching value (connectivity), N=normalized value (normalization).

In equation 1, the size of(Entry) means the size of a population of the selected speech segments in the synthesis unit DB, C means information on connection among the speech segments, and the estimated value and the actual value mean an estimated value for the length, size and pitch of the speech segment, and an actual value of the selected speech segment, respectively.

The history manager 350 selects words of which the emphasis frequencies exceed the threshold value as words, which are unnecessary to be emphasized, from emphasis words selected by the emphasis word selection unit 330 by referring to the emphasis frequency information stored in the history DB 310.

The threshold value is a value indicating the degree that the user can easily recognize words since the words have been frequently used or emphasized in the input text. For example, its value is set to a numerical value such as 5 times.

The information type determination module 500 determines the information type of the input text data by using the speech synthesis analysis data obtained from the speech synthesis module 100 and generates sentence pattern information. In addition, it includes a domain DB 510, a semantic analysis unit 530, and a sentence pattern information-generating unit 550.

Herein, the information type indicates the field of the type (hereinafter, referred to as “domain”), which information provided in the input text represents, and the sentence pattern information indicates a general structure of actual information for displaying the selected emphasis words to be most suitable for the information type of the input text.

For example, if a text about the securities market such as “The NASDAQ composite index closed down 40.30 to 1,356.95” is input, the information type of the input text is the current status of the securities, and the sentence pattern information is an INDEX VALUE type which is a general structure of noun phrases (INDEX) and numerals (VALUE) corresponding to actual information in the current status of the securities that is the information type of the input text.

Information on grammatical rules, terminologies and phrases for information, which is divided according to the information type, is stored as domain information in the domain DB 510.

Each of the grammatical rules is obtained by causing an information structure of each domain to be grammar so that items corresponding to the information can be extracted from a syntactic structure of the input text.

For example, the grammatical rule used in the above example sentence provides only the price value of a stock, which is important to the user, among “INDEX close (or end) VALUE to VALUE” that is a general sentence structure used in the information type of the current status of the securities. The grammatical rule can be defined as follows:

NP{INDEX} VP{Verb(close) PP{*} PP{to VALUE}}→INDEX VALUE,

NP{INDEX} VP{Verb(end) PP{*} PP{to VALUE}}→INDEX VALUE.

In addition, the terminology and phrase information is information on words that are frequently used or emphasized in specific domains, phrases (e.g., “NASDAQ composite index” in the above example sentence) that can be divided as one semantic unit (chunk), and the terminologies that are frequently used as abbreviations in the specific domains (e.g., “The NASDAQ composite index” is abbreviated as “NASDAQ” in the above example sentence), and the like.

The semantic analysis unit 530 represents a predetermined semantic analysis means which is additionally provided if semantic analysis is required in order to obtain semantic information on the text data in addition to the speech synthesis analysis data obtained from the speech synthesis module 100.

The sentence pattern information-generating unit 550 selects representative words corresponding to the actual information from the input text data by referring to the speech synthesis analysis data obtained from the speech synthesis module 100 and the domain information stored in the domain DB 510, determines the information type, and generates the sentence pattern information.

The structuring module 700 rearranges the selected emphasis words in accordance with the sentence pattern information obtained from the sentence pattern information-generating unit 500, and adapts them to a predetermined layout format. In addition, it includes a sentence pattern information-adaptation unit 710, a meta DB 730 and an information-structuring unit 750, as shown in FIG. 2.

The sentence pattern information-adaptation unit 710 determines whether the sentence pattern information generated from the information type-determining module 500 exists; if the sentence pattern information exists, adapts the emphasis words selected by the emphasis word selection module 300 to the sentence pattern information and outputs them to the information-structuring unit 750; and if not, outputs only emphasis words, which have not been adapted to the sentence pattern information, to the information-structuring unit 750.

In the meta DB 730, layout (for example, a table) for structurally displaying the selected emphasis words in accordance with the information type, and the contents (e.g., “:”, “;”, etc.) to be additionally displayed.

In addition, timing information on the meta information is also stored therein in order to suitably display respective meta information together with the synthesized sounds.

The information-structuring unit 750 extracts the meta information on a relevant information type from the meta DB 730 by using the information type and the emphasis words for the input text, and the timing information on the emphasis words obtained from the speech synthesis module 100; tags the emphasis words and the timing information to the extracted meta information; and outputs them to the display module 900.

For example, as for the information type of the current status of the securities such as in the example sentence, if it is set such that INDEX and VALUE, which are the actual information, are displayed as the layout in the form of a table, they are tagged with the timing information (SYNC=“12345”, SYNC=“12348”) for the INDEX information and the VALUE information obtained from the speech synthesis module 100.

The emphasis words structured together with the timing information in the layout format designated through this procedure are as follows:

```
<INDEXVALUE ITEM = “1”>
  <INDEX SYNC = “12345”>INDEX(NASDAQ)</INDEX>
  <VALUE SYNC = “12438”>VALUE(1,356.95)</VALUE>
</INDEXVALUE>
```

The display module 900 synchronizes the structured emphasis words with the synthesized sounds in accordance with the timing information and displays them. The display module 900 includes a synchronizing unit 910, a video signal-processing unit 930 and a display unit 950 as shown in FIG. 2.

The synchronizing unit 910 extracts respective timing information on the meta information and the emphasis words, and synchronizes the synthesized sounds output through the speaker 190 of the speech synthesis module 100 with the emphasis words and the meta information so that they can be properly displayed.

The video signal-processing unit 930 processes the structured emphasis words into video signals in accordance with the timing information obtained from the synchronizing unit 910 so as to be output to the display unit 950.

The display unit 950 visually displays the emphasis words in accordance with the display information output from the video signal-processing unit 930.

For example, the structured example sentence output from the structuring module 700 is displayed thereon through the display unit 950 as follows:

| | |
|---|---|
| NASDAQ | 1,356.95 |

Hereinafter, a text-to-speech conversion method having the function of providing additional information according to the present invention will be described in detail with reference to the accompanying drawings.

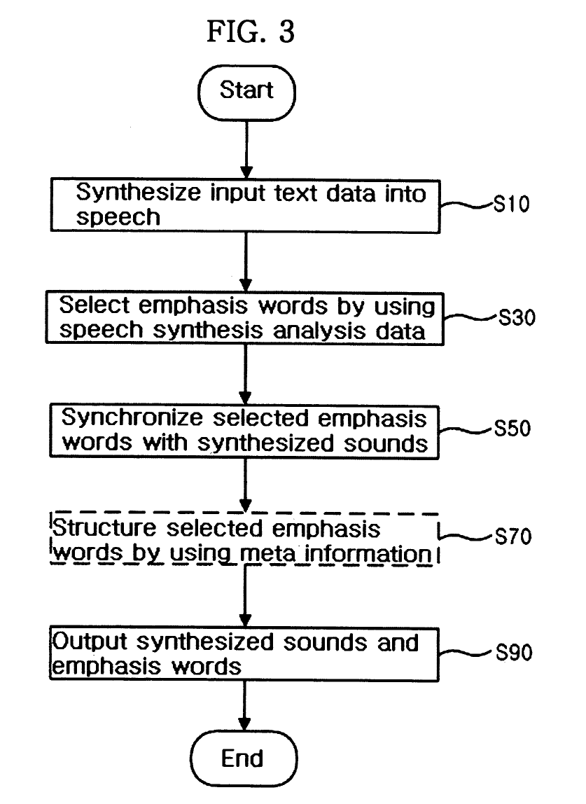

FIG. 3 is a flowchart illustrating an operational process of the text-to-speech conversion method having the function of providing the additional information according to an embodiment of the present invention.

First, the speech synthesis module 100 performs the morpheme and syntactic analysis processes for the input text by the morpheme analysis unit 110 and the syntactic analysis unit 130, and synthesizes the input text data into the speech by referring to the speech synthesis analysis data obtained through the morpheme and syntactic analysis processes (S10).

When the speech synthesis module 100 generates the synthesized sounds, the emphasis word selection unit 330 of the emphasis word selection module 300 selects words, which are expected to be difficult for the user to recognize or belong to specific parts of speech, as emphasis words by using the speech synthesis analysis data obtained from the speech synthesis module 100 (S30).

When the emphasis word selection unit 330 selects the emphasis words, the selected emphasis words and the timing information obtained from the speech synthesis module 100 are used to synchronize them with each other (S50).

The display module 900 extracts the timing information from the emphasis words that are structured with the timing information, synchronizes them with the synthesized sounds output through the speaker 190 of the speech synthesis module 100, and displays them on the display unit 950 (S90).

Additionally, the selected emphasis words are structured by extracting the meta information corresponding to the predetermined layout format from the meta DB 730 and adapting the emphasis words to the extracted meta information (S70).

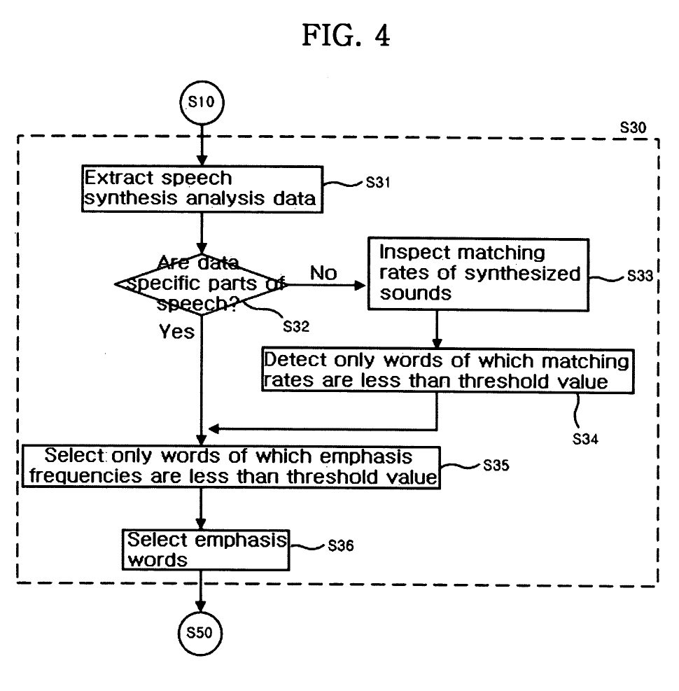

FIG. 4 shows the step of selecting the emphasis words (S30) in more detail. As shown in the figure, the emphasis word selection unit 330 extracts the speech synthesis analysis data obtained from the speech synthesis module 100 (S31).

Then, it is determined whether the part of speech of each word, which is divided based on morpheme in accordance with the morpheme analysis process performed by the morpheme analysis unit 110 of the speech synthesis module 100, belongs to the specific part of speech by using the extracted speech synthesis analysis data, and a word corresponding to the designated specific part of speech is selected as an emphasis word (S32).

In addition, the matching rates of the synthesized sounds of words are inspected using the extracted speech synthesis analysis data, in order to provide words, which are expected to be difficult for the user to recognize, by means of emphasis words (S33). As the result of inspection of the matching rates of the synthesized sounds, words that are expected to have the distortion of the synthesized sounds are extracted and selected as emphasis words (S34).

In case of inspecting the matching rates of the synthesized sounds, each of the matching rates is calculated from the difference between the output value (estimated value) of the synthesized sound, which is estimated for each speech segment of each word from the extracted speech synthesis analysis data, and the actual output value (actual value) of the synthesized sound, by using equation 1. A word of which the average value of the calculated matching rates is less than the threshold value is searched.

The threshold value indicates an average value of matching rates of a synthesized sound that the user cannot recognize and is set as a numerical value such as 50%.

Further, in order to select words that the user can easily recognize among the emphasis words selected through the above processes as words that are unnecessary to be emphasized, the emphasis word selection unit 330 selects words, which are unnecessary to be emphasized among the extracted emphasis words through the history manager 350 (S35).

That is, the history manager 350 selects words of which the emphasis frequencies are higher than the threshold value and the possibility that the user cannot recognize them is low among the emphasis words extracted by the emphasis word selection unit 330 by referring to the emphasis frequency information obtained from the speech synthesis module 100 stored in the history DB 310.

The emphasis word selection unit 330 selects the words, which belong to the specific parts of speech and are expected to be difficult for the user to recognize from the input text, through the process of selecting the words that are unnecessary to be emphasized by the history manager 350 (S36).

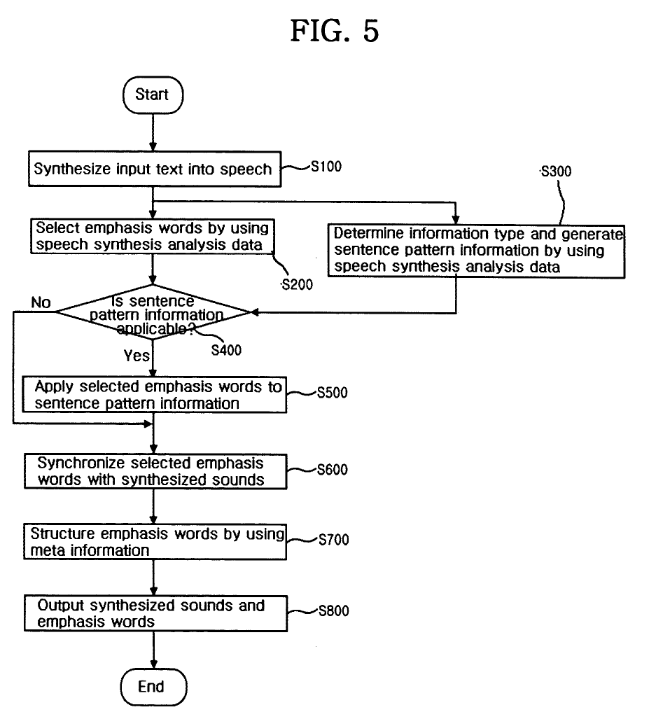

FIG. 5 shows a speech generating process in a text-to-speech conversation method having a function of providing additional information according to another embodiment of the present invention. The embodiment of FIG. 5 will be described by again referring to FIGS. 3 and 4.

First, the text input through the speech synthesis module 100 is converted into speech (S100, see step S10 in FIG. 3), and the emphasis word selection unit 330 selects emphasis words by using the speech synthesis analysis data obtained from the speech synthesis module 100 (S200, see the step S30 in FIGS. 3 and 4).

Further, the sentence pattern information-generating unit 550 of the information type-determining module 500 determines the information type of the input text by using the speech synthesis analysis data obtained from the speech synthesis module 100 and the domain information extracted from the domain DB 530, and generates the sentence pattern information (S300).

Then, the sentence pattern information-adaptation unit 710 of the structuring unit 700 determines the possibility of applying the sentence pattern information by determining whether the sentence pattern information to which the selected emphasis words will be adapted is generated from the information type-determining module 500 (S400).

If it is determined that the sentence pattern information can be applied, rearrangement is done by adapting the selected emphasis words to the sentence pattern information (S500).

Then, the emphasis words that have been adapted or not to the sentence pattern are synchronized with the timing information obtained from the speech synthesis module 100 (S600, see step S50 in FIG. 3).

The display module 900 extracts the timing information from the emphasis words that are structured with the timing information, properly synchronizes them with the synthesized sounds that are output through the speaker 190 of the speech synthesis module 100, and displays them on the display unit 950 (S800, see step S90 in FIG. 3).

Additionally, the information-structuring unit 750 of the structuring module 700 extracts the meta information on the relevant information type from the meta information DB 730, and structuralizes the emphasis words that have been adapted or not to the sentence pattern information in the predetermined layout format (S700, see step S70 in FIG. 3).

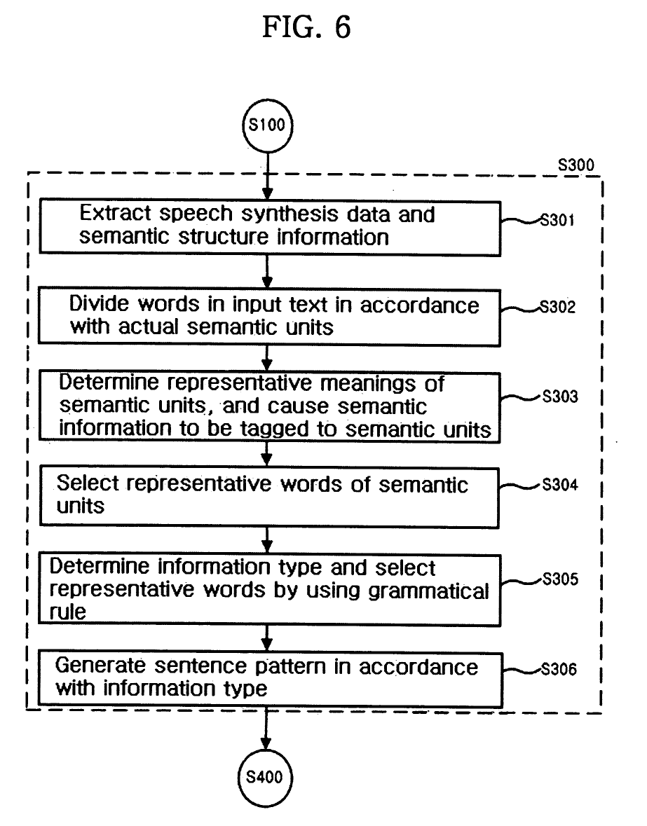

FIG. 6 specifically shows step S300 of determining the information type and generating the sentence pattern information in FIG. 5. The step will be described in detail by way of example with reference to the figures.

First, the sentence pattern information-generating unit 550 of the information type-determining module 500 extracts the speech synthesis analysis data from the speech synthesis module 100; and if the information on the semantic structure of the input text is required additionally, analyzes the semantic structure of the text through the semantic analysis unit 530 and extracts the meaning structure information of the input text (S301).

Then, respective words of the input text are divided based on the actual semantic units by referring to the extracted speech synthesis analysis data, the semantic structure information, and the domain DB 510 (S302).

After dividing the input text based on the semantic units (chunk), the representative meanings for indicating divided semantic units are determined and respective semantic units are tagged with the determined semantic information (S303), and representative words of the respective semantic units are selected by referring to the domain DB 510 (S304).

For example, in the above example sentence corresponding to the information type of the current status of the securities, if the semantic units are divided into “/The NASDAQ composite index/close/down/40.30/to/1,356.95/”, the semantic information, i.e. information designating the respective semantic units, is defined as follows:

The NASDAQ composite index: INDEX,

close: close,

down: down,

to: to,

number class (40.30, 1,356.95): VALUE.

If the above-defined semantic information is tagged to the input text that is divided based on the semantic units, the following is established.

/INDEX/close/down/VALUE/to/VALUE.

In addition, if the representative words of the respective semantic units are selected from the input text, which has been divided based on the semantic units, by referring to the terminology and phrase information stored in the domain DB 510, it is determined as follows:

/NASDAQ/close/down/40.30/to/ 1,356.95/.

Words to be provided to the user as the actual information are selected from the representative words through such processes.

After selecting the representative words, the sentence pattern information-generating unit 550 extracts the grammatical rule applicable to the syntactic and semantic structure of the input text from the domain DB 510, and selects the information type and the representative words to be expressed as the actual information through the extracted grammatical rule (S305).

For example, referring to the information type-determining process for the above example sentence in the description of the grammatical rule previously stored in the domain DB 510, if the syntactic structure of the text input to “NP{INDEX} VP{Verb(close) PP{*} PP{to VALUE}}→INDEX VALUE”conforms to the grammar provided as the grammatical rule of the determined information type, adaptation of the text divided based on the semantic units to the detected grammatical rule results in the following.

INFO[The NASDAQ composite index/INDEX]closed down 40.30 to INFO[1,356.95/VALUE].

In such a way, the information type of the input text is determined during the process of applying the grammatical rule, and the representative words [(INDEX, VALUE)] to be expressed as the actual information are selected.

If the information type is determined and the representative words to be expressed as the actual information are selected, the sentence pattern information for displaying the selected representative words most suitably to the determined information type is generated (S306).

For example, the sentence pattern information generated in above example sentence is the “INDEX VALUE” type.

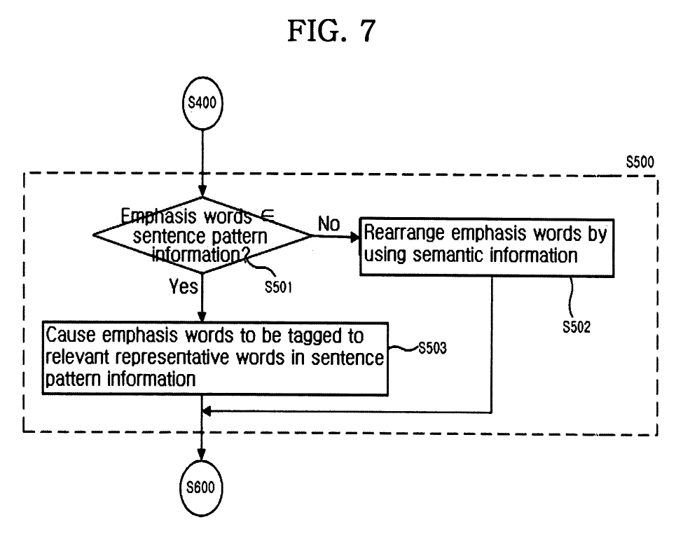

FIG. 7 specifically shows step S500 of applying the sentence pattern information in FIG. 5. The process will be described in detail by way of example with reference to the figures.

First, in order to determine whether the emphasis words selected by the emphasis word selection module 300 are adapted to the generated sentence pattern information, it is determined whether the selected emphasis words are included in the representative words to be expressed as the actual information which are selected from the sentence pattern information generated from the sentence pattern information-generating unit 550 (S501).

If it is determined that the selected emphasis words are not included in the representative words, the selected emphasis words are rearranged in accordance with the syntactic structure of the information type determined in the process of generating the sentence pattern information (S502), and if not, the emphasis words are rearranged by tagging the emphasis words to the relevant representative words in the sentence pattern information (S503).

Embodiments in which the text-to-speech conversion system and method having the function of providing the additional information according to the present invention are implemented through a mobile terminal will be described with reference to the accompanying drawings.

Hereinafter, preferred embodiments of the present invention will be described with reference to processes of detecting and displaying emphasis words, rearranging the detected emphasis words according to syntactic pattern information and then displaying them, and applying the detected emphasis words to the syntactic pattern information and then organizing them with meta information and displaying them.

Additionally, processes for interpretation of morpheme/structure and detection of an emphasis word can be applied to various linguistic environments, and herein Korean and English are used.

### EMBODIMENT 1

An example, where the emphasis words are selected through the emphasis word selection module 300 and only the selected emphasis words are then displayed when the following text is input, is explained:

“GE [symbol] [symbol] [symbol] ‘GE [symbol] [symbol] [symbol] [symbol] [symbol] [symbol] [GE bæksæk gadj [symbol] nen ya [symbol] mun y [symbol] dadji næ [symbol] dja [symbol] goin ‘GE Profile Artica’rel tƒulsihandago 8wol 9il balky [symbol] tda]

This means “GE Appliances announced on August 9 that it would present the side-by-side refrigerator, ‘GE Profile Artica’”.

If such a text is input, the speech synthesis module 100 divides the input text into parts of speech such as the noun, the adjective, the adverb and the particle in accordance with the morpheme through the morpheme analysis unit 110 so as to perform the speech synthesis of the input text. The result is as follows:

“GE/foreign word+ [symbol] (bæksæk)/noun+ [symbol] (gadj [symbol] n)/noun+ [symbol] (en)/particle+ [symbol] (ya [symbol] muny [symbol] dadji)/noun+ [symbol] (næ [symbol] dja [symbol] go)/noun+ [symbol] (in)/predicate+GE/foreign word+ [symbol] (Profile)/noun+ [symbol] (Artica)/proper noun+ [symbol] (rel)/particle+ [symbol] (tƒulsihanda)/predicate+ [symbol] (go)/connecting suffix+8/numeral+ [symbol] (wol)/noun+9/numeral+ [symbol] (il)/noun+ [symbol] (balky [symbol] t)/predicate+ [symbol] (da)/ending suffix.”

After the sentence has been analyzed as such in accordance with the morpheme by the morpheme analysis unit 110, the speech synthesis analysis data are generated through the processes of analyzing the sentence structure of the input text data in the sentence structure analysis unit 130, referring to the analyzed sentence structure, and synthesizing the speech in the speech synthesis unit 150.

The emphasis word selection unit 330 of the emphasis word selection module 300 extracts the words belonging to the predetermined specific parts of speech from the words divided in accordance with the morpheme in the input text data, by using the speech synthesis analysis data obtained from the speech synthesis module 100.

In the present embodiment, if the proper noun, the loanword, and the numeral are designated as the specific part of speech, the emphasis word selection unit 330 extracts ‘GE [symbol] ’ from the input text as words belonging to the predetermined specific parts of speech.

In addition, if words that are expected to be difficult for the user to recognize are to be selected as emphasis words, the emphasis word selection unit 330 detects the matching rates of the synthesized sounds of the words in the input text data in accordance with equation 1.

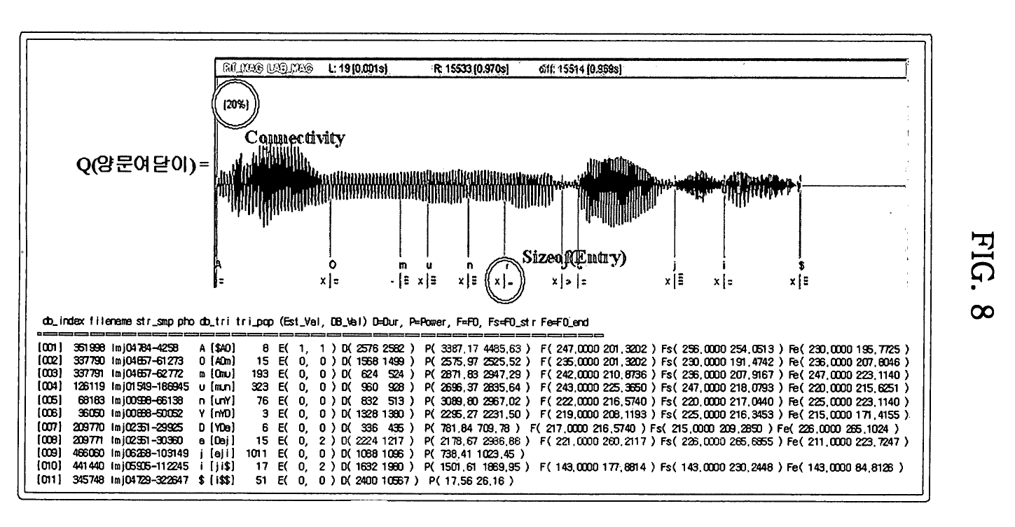

Then, if the matching rate of the word “ [symbol] ” is calculated as 20% as shown in FIG. 8, the word “ [symbol] ” is detected as a word that is expected to have the distortion of the synthesized sound since the calculated matching rate is lower than the threshold value in a case where the set threshold value is 50%.

Through the processes, the words “GE [symbol] [symbol] ” are detected as the emphasis words that belong to the specific parts of speech and are expected to have the distortion of the synthesized sounds.

Additionally, if the words, which are frequently used in the input text and of which emphasis frequencies are higher than the predetermined threshold value, are to be selected among the selected emphasis words as the words that are unnecessary to be emphasized, the emphasis word selection unit 330 selects words of which emphasis frequencies are higher than the threshold value among the emphasis words extracted by the history manager 350.

In the embodiment, if all the selected emphasis words have emphasis frequencies less than the threshold value, final emphasis words are selected as the words “GE [symbol] [symbol] ”.

The structuring module 700 structures the selected emphasis words together with the timing information obtained from the speech synthesis module 100. The display module 900 extracts the timing information from the structured emphasis words and displays the emphasis words onto the display unit 950 together with the synthesized sounds output from the speech synthesis module 100.

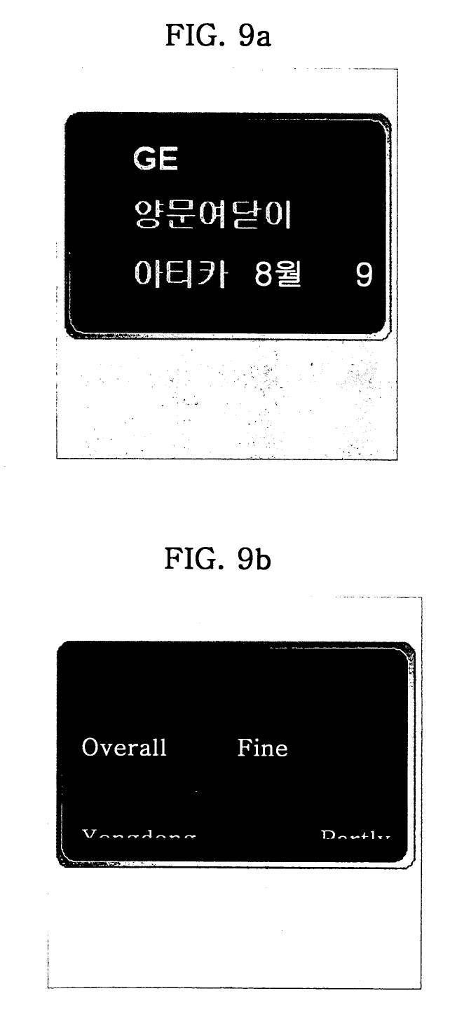

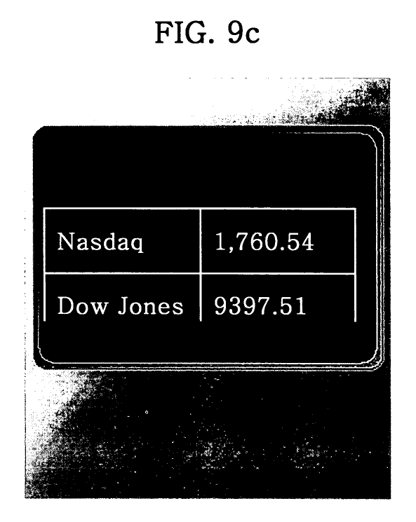

The emphasis words displayed on the display unit 950 are shown in FIG. 9a.

Furthermore, the selected emphasis words may be displayed in accordance with the predetermined layout format extracted from the meta DB 730.

### EMBODIMENT 2

Another example, where the emphasis words are selected by the emphasis word selection module 300 and the selected emphasis words are rearranged and displayed in accordance with the sentence pattern information when the following text is input, will be explained:

“The whole country will be fine but in the Yongdong district it will become partly cloudy.”

Hereinafter, it is assumed that the selected emphasis words correspond to the representative words of the actual information selected in the process of determining the information type. Thus, the description on the process of selecting the emphasis words is omitted and only the process of displaying the emphasis words in accordance with the sentence pattern information will be described.

First, the information type-determining module 500 divides the words of the input text based on their actual semantic units by referring to the speech synthesis analysis data obtained from the speech synthesis module 100 and the domain information extracted from the domain DB 510. The result is expressed as follows:

“/The whole country/will be/fine/but/in/the Yongdong district/it/will become/partly cloudy./”

The input text is divided based on the actual semantic units, and the representative meanings are then determined for the divided semantic units so that the determined representative meanings are attached to the respective semantic units. The result with the representative meaning tagged thereto is expressed as follows:

“/REGION/will be/FINE/but/in/REGION/it/will become/CLOUDY/”

In addition, if the representative words of the respective semantic units are selected from the input text that is divided in accordance with the semantic units by referring to the information on the terminologies and phrases stored in the domain DB 510, the result may also be expressed as follows:

“/whole country/be/fine/but/in/Yongdong/it/become/partly cloudy./”

Words, which will be provided to the user as the actual information, are selected among the words selected through the above processes. The sentence pattern information-generating unit 550 extracts the grammatical rule applicable to the syntactic and semantic structure of the text data input from the domain DB 510.

If the following grammatical rule applicable to the text provided in this example is extracted from the information type of weather forecast in the same manner as the following rule, the information type of the input text is determined as the weather forecast.

NP{REGION} VP{be FINE}→REGION FINE

PP{in NP{REGION}} NP{it} VP{become CLOUDY}→REGION CLOUDY

If the information type is determined, the input text data are applied to the extracted grammatical rule. The result with the grammatical rule applied thereto is expressed as follows:

“INFO[The whole country/REGION] will be INFO[fine/FINE] but in INFO[the Yongdong district/REGION] it will become INFO[partly cloudy/CLOUDY].”

As described above, the information type of the input text is determined in the process of applying the grammatical rule, and the representative words (i.e., The whole country/REGION, fine/FINE, the Yongdong district/REGION, partly cloudy/CLOUDY) to be expressed as the actual information are selected.

If the information type is determined and the representative words to be expressed as the actual information are selected, the sentence pattern for displaying the selected representative words in the most suitable manner to the determined information type is generated.

For example, the sentence pattern information generated from the text is ‘REGION WEATHER’ type.

If the sentence pattern information is generated through above process, the sentence pattern information-adaptation unit 910 rearranges the selected emphasis words in accordance with the generated sentence pattern information.

In the embodiment, if the selected emphasis words correspond to the words selected from the sentence pattern information as the representative words to be expressed as the actual information, the emphasis words and the timing information of the respective emphasis words obtained from the speech synthesis module 100 are tagged to the sentence pattern information in order to structure the emphasis words.

The structured emphasis words are expressed as follows:

<REGIONWEATHER ITEM=“3”>

<REGION VALUE=“0” SYNC=“1035”>the whole country </REGION>

<WEATHER EVAL=“CLOUD” SYNC=“1497”>fine</WEATHER>

.

.

</REGION WEATHER>

The display module 900 displays the structured emphasis words together with the synthesized sounds in a state where they are synchronized with each other in accordance with the timing information.

The display result is shown in FIG. 9b.

### EMBODIMENT 3

A further example, where the emphasis words are selected by the emphasis word selection module 300 and the selected emphasis words are structured with and displayed together with the meta information in accordance with to the sentence pattern information when the following text is input, will be explained:

“Today, the Nasdaq composite index closed down 0.57 to 1,760.54 and the Dow Jones industrial average finished up 31.39 to 9397.51.”

Hereinafter, it is assumed that the selected emphasis words correspond to the representative words of the actual information selected in the process of determining the information type. Thus, the description on the process of selecting the emphasis words is omitted and only the process of displaying the emphasis words in accordance with the sentence pattern information will be described.

The speech synthesis module 100 analyzes the input text in accordance with the morpheme and the semantic structure and synthesizes the analyzed text into speech.

The emphasis word selection module 300 selects the emphasis words from the text input through the emphasis word selection unit 330. The information type-determining module 500 determines the information type of the text input through the domain DB 510 and generates the sentence pattern information.

The process of determining the information type using the input text will be described in detail. The words of the input text are divided according to the respective actual semantic units by using the morpheme and semantic structure information obtained from the TTS 100 and the semantic unit DB of the domain DB 510. The result is expressed as follows:

“/Today,/the Nasdaq composite index/closed/down/0.57/to/1,760.54/and/the Dow Jones industrial average/finished/up/31.39/to/9397.51./”

The input text is divided based on the actual semantic units, and the representative meanings are then determined from the input text, which is divided based on the semantic units by referring to the domain DB 510, so that the determined representative meanings are tagged to the semantic units. The result with the representative meaning tagged thereto is expressed as follows:

“/DATE/INDEX/closed/down/VALUE/to/VALUE/and/INDEX/finished/up/VALUE/to/VALUE/”

Then, the representative words of the respective semantic units of the input text are selected, and the result with the selected representative words applied thereto may be expressed as follows:

“/Today/Nasdaq/close/down/0.57/to/1,760.54/and/Dow/finish/up/31.39/to/9397.51./”

Then, the grammatical rule to which the syntactic and semantic structure of the text input from the domain DB 510 is applied is extracted, and only the portion corresponding to the actual information in the input text is displayed by applying the extracted grammatical rule to the input text that is divided in accordance with the respective semantic units.

That is, if the syntactic structure of the input text corresponds to the following grammatical rule provided in the information type of the present status of the stock market, the information type of the input text is determined as the present status of the stock market.

NP{DATE}, NP{INDEX} VP{close PP{*} PP{to VALUE}}→DATE INDEX VALUE

NP{INDEX} VP{finish PP{*} PP{to VALUE}}→INDEX VALUE

When the input text is applied to the extracted grammatical rule, the text is expressed as follows:

“INFO[Today/DATE], INFO[the Nasdaq composite index/INDEX] closed down 0.57 to INFO[1,760.54/VALUE] and INFO[the Dow Jones industrial average/INDEX] finished up 31.39 to INFO[9397.51/VALUE].”

As a result, the representative words (i.e., Today/DATE, Nasdaq/INDEX, 1,760.54/VALUE, DOW/INDEX, 9397.51/VALUE) to be displayed as the actual information are selected. Then, an INDEX VALUE type is generated as the sentence pattern information for displaying the representative words in the most suitable manner to the determined information type.

When the sentence pattern information is generated through the above process, the sentence pattern information to which the emphasis words selected by the emphasis word selection module 300 will be applied exists as the result of determining whether the sentence pattern information exists by the sentence pattern information-adaptation unit 710 of the structuring module 700. Thus, it is determined whether the selected emphasis words can be applied to the sentence pattern information generated from the information type-determining module 500.

If the emphasis words selected in the emphasis word selection module 300 are included in the words selected in the information type-determining module 500 as the representative words to be displayed as the actual information, the sentence pattern adaptation unit 710 causes the emphasis words to be tagged to the generated sentence pattern information.

However, if the selected emphasis words are not included in the words selected as the representative words in the information type-determining module 500, the emphasis words are rearranged in accordance with the syntactic structure of the determined information type.

When the emphasis words are tagged to the sentence pattern information or rearranged in accordance with the syntactic structure in the above manner, the information-structuring unit 750 extracts the meta information for laying out the emphasis words in accordance with the information type from the meta DB 730 and causes the emphasis words to be tagged to the extracted meta information.

In the process of causing the emphasis words to be tagged to the meta information, the corresponding synthesized sounds designated to each of the emphasis words are set together with the timing information.

If the information is expressed in such a manner that the DATE becomes the TITLE and the INDEX and VALUE are provided in the form of a table structure according to the respective items in the information type related to the stock market, the layout format expressed as a table form is extracted from the meta DB 730. The emphasis words and the timing information are input into the extracted layout, as follows:

<TITLE SYNC=“510”>Today </TITLE>

<INDEXVALUE ITEM=“2”>

<INDEX SYNC=“1351”>Nasdaq </INDEX>

<VALUE SYNC=“INHERIT”>1,760.54</VALUE>

.

.

</INDEXVALUE>

As a result, as shown in FIG. 9c, the selected emphasis words are displayed together with the corresponding synthesized sounds in such a manner that the VALUE corresponding to the items of the composite stock price index is shown together with the INDEX by an ‘INHERIT’ tag.

According to the present invention, the user can visually confirm the words that are difficult for the user to recognize. Thus, restrictions on time and recognition inherent to the speech can be reduced.

In addition, the user can understand more intuitively the contents of the information provided in the form of synthesized sounds through the structurally displayed additional information. Thus, there is an advantage in that the information delivery capability and reliability of the TTS can be improved.

Furthermore, the operating efficiency of the text-to-speech conversion system can be maximized.

Although the present invention has been described in connection with the embodiments shown in the accompanying drawings, it is merely illustrative. Thus, it will be readily understood to those skilled in the art that various modifications and other equivalents can be made thereto. Therefore, the true technical scope and spirit of the present invention should be defined by the appended claims.

What is claimed is:

1. A text-to-speech conversion system, comprising:
a speech synthesis module for analyzing text data in accordance with morphemes and a syntactic structure, synthesizing the text data into speech by using obtained speech synthesis analysis data, and outputting synthesized sounds;
an emphasis word selection module for selecting words belonging to specific parts of speech as emphasis words from the text data by using the speech synthesis analysis data obtained from the speech synthesis module; and
a display module for displaying the selected emphasis words in synchronization with the synthesized sounds.

2. The text-to-speech conversion system as claimed in claim 1, further comprising a structuring module for structuring the selected emphasis words in accordance with a predetermined layout format.

3. The text-to-speech conversion system as claimed in claim 2, wherein the structuring module comprises:
a meta DB in which layouts for structurally displaying the emphasis words selected in accordance with the information type and additionally displayed contents are stored as meta information;
a sentence pattern information-adaptation unit for rearranging the emphasis words selected from the emphasis word selection module in accordance with the sentence pattern information; and
an information-structuring unit for extracting the meta information corresponding to the determined information type from the meta DB and applying the rearranged emphasis words to the extracted meta information.

4. The text-to-speech conversion system as claimed in claim 1, wherein the emphasis words include words that are expected to have distortion of the synthesized sounds among words in the text data by using the speech synthesis analysis data obtained from the speech synthesis module.

5. The text-to-speech conversion system as claimed in claim 4, wherein the words that are expected to have the distortion of the synthesized sounds are words of which matching rates are less than a predetermined threshold value, each of said matching rates being determined on the basis of a difference between estimated output and an actual value of the synthesized sound of each speech segment of each word.

6. The text-to-speech conversion system as claimed in claim 5, wherein the difference between the estimated output and actual value is calculated in accordance with the following equation:
ΣQ(sizeof(Entry), |estimated value−actual value|, C)/N,
where C is a matching value (connectivity) and N is a normalized value (normalization).

7. The text-to-speech conversion system as claimed in claim 1, wherein the emphasis words are selected from words of which emphasis frequencies are less than a predetermined threshold value by using information on the emphasis frequencies for the respective words in the text data obtained from the speech synthesis module.

8. A text-to-speech conversion system, comprising:
a speech synthesis module for analyzing text data in accordance with morphemes and a syntactic structure, synthesizing the text data into speech by using obtained speech synthesis analysis data, and outputting synthesized sounds;
an emphasis word selection module for selecting words belonging to specific parts of speech as emphasis words from the text data by using the speech synthesis analysis data obtained from the speech synthesis module; and
an information type-determining module for determining information type of the text data by using the speech synthesis analysis data obtained from the speech synthesis module, and generating sentence pattern information; and
a display module for rearranging the selected emphasis words in accordance with the generated sentence pattern information and displaying the rearranged emphasis words in synchronization with the synthesized sounds.

9. The text-to-speech conversion system as claimed in claim 8, further comprising a structuring module for structuring the selected emphasis words in accordance with a predetermined layout format.

10. The text-to-speech conversion system as claimed in claim 9, wherein the structuring module comprises:
a meta DB in which layouts for structurally displaying the emphasis words selected in accordance with the information type and additionally displayed contents are stored as meta information;
a sentence pattern information-adaptation unit for rearranging the emphasis words selected from the emphasis word selection module in accordance with the sentence pattern information; and
an information-structuring unit for extracting the meta information corresponding to the determined information type from the meta DB and applying the rearranged emphasis words to the extracted meta information.

11. The text-to-speech conversion system as claimed in claim 8, wherein the emphasis words include words that are expected to have distortion of the synthesized sounds among words in the text data by using the speech synthesis analysis data obtained from the speech synthesis module.

12. The text-to-speech conversion system as claimed in claim 11, wherein the words that are expected to have the distortion of the synthesized sounds are words of which matching rates are less than a predetermined threshold value, each of said matching rates being determined on the basis of a difference between estimated output and an actual value of the synthesized sound of each speech segment of each word.

13. The text-to-speech conversion system as claimed in claim 12, wherein the difference between the estimated output and actual value is calculated in accordance with the following equation:
ΣQ(sizeof(Entry), |estimated value−actual value|, C)/N,
where C is a matching value (connectivity) and N is a normalized value (normalization).

14. The text-to-speech conversion system as claimed in claim 8, wherein the emphasis words are selected from words of which emphasis frequencies are less than a predetermined threshold value by using information on the emphasis frequencies for the respective words in the text data obtained from the speech synthesis module.

15. A text-to-speech conversion method, the method comprising the steps of:
a speech synthesis step for analyzing text data in accordance with morphemes and a syntactic structure, synthesizing the text data into speech by using obtained speech synthesis analysis data, and outputting synthesized sounds;
an emphasis word selection step for selecting words belonging to specific parts of speech as emphasis words from the text data by using the speech synthesis analysis data; and
a display step for displaying the selected emphasis words in synchronization with the synthesized sounds.

16. The text-to-speech conversion method as claimed in claim 15, further comprising a structuring step for structuring the selected emphasis words in accordance with a predetermined layout format.

17. The text-to-speech conversion method as claimed in claim 16, wherein the structuring step comprises the steps of:
determining whether the selected emphasis words are applicable to the information type of the generated sentence pattern information;
causing the emphasis words to be tagged to the sentence pattern information in accordance with a result of the determining step or rearranging the emphasis words in accordance with the determined information type; and
structuring the rearranged emphasis words in accordance with meta information corresponding to the information type extracted from the meta DB.

18. The text-to-speech conversion method as claimed in claim 18, wherein layouts for structurally displaying the emphasis words selected in accordance with the information type and additionally displayed contents are stored as the meta information in the meta DB.

19. The text-to-speech conversion method as claimed in claim 15, wherein the emphasis word selecting step further comprises the step of selecting words that are expected to have distortion of the synthesized sounds from words in the text data by using the speech synthesis analysis data obtained from the speech synthesis step.

20. The text-to-speech conversion method as claimed in claim 19, wherein the words that are expected to have the distortion of the synthesized sounds are words of which matching rates are less than a predetermined threshold value, each of said matching rates being determined on the basis of a difference between estimated output and an actual value of the synthesized sound of each speech segment of each word.

21. The text-to-speech conversion method as claimed in claim 15, wherein in the emphasis word selection step, the emphasis words are selected from words of which emphasis frequencies are less than a predetermined threshold value by using information on the emphasis frequencies for the respective words in the text data obtained from the speech synthesis step.

22. A text-to-speech conversion method, the method comprising the steps of:
a speech synthesis step for analyzing text data in accordance with morphemes and a syntactic structure, synthesizing the text data into speech by using obtained speech synthesis analysis data, and outputting synthesized sounds;
an emphasis word selection step for selecting words belonging to specific parts of speech as emphasis words from the text data by using the speech synthesis analysis data; and
a sentence pattern information-generating step for determining information type of the text data by using the speech synthesis analysis data obtained from the speech synthesis step, and generating sentence pattern information; and
a display step for rearranging the selected emphasis words in accordance with the generated sentence pattern information and displaying the rearranged emphasis words in synchronization with the synthesized sounds.

23. The text-to-speech conversion method as claimed in claim 22, wherein the emphasis word selecting step further comprises the step of selecting words that are expected to have distortion of the synthesized sounds from words in the text data by using the speech synthesis analysis data obtained from the speech synthesis step.

24. The text-to-speech conversion method as claimed in claim 23, wherein the words that are expected to have the distortion of the synthesized sounds are words of which matching rates are less than a predetermined threshold value, each of said matching rates being determined on the basis of a difference between estimated output and an actual value of the synthesized sound of each speech segment of each word.

25. The text-to-speech conversion method as claimed in claim 22, wherein in the emphasis word selection step, the emphasis words are selected from words of which emphasis frequencies are less than a predetermined threshold value by using information on the emphasis frequencies for the respective words in the text data obtained from the speech synthesis step.

26. The text-to-speech conversion method as claimed in claim 22, wherein the sentence pattern information-generating step comprises the steps of:
dividing the text data into semantic units by referring to a domain DB and the speech synthesis analysis data obtained in the speech synthesis step;
determining representative meanings of the divided semantic units, tagging the representative meanings to the semantic units, and selecting representative words from the respective semantic units;
extracting a grammatical rule suitable for a syntactic structure format of the text from the domain DB, and determining actual information by applying the extracted grammatical rule to the text data; and
determining the information type of the text data through the determined actual information, and generating the sentence pattern information.

27. The text-to-speech conversion method as claimed in claim 26, wherein information on a syntactic structure, a grammatical rule, terminologies and phrases of various fields divided in accordance with the information type is stored as domain information in the domain DB.

28. The text-to-speech conversion method as claimed in claim 22, further comprising a structuring step for structuring the selected emphasis words in accordance with a predetermined layout format.

29. The text-to-speech conversion method as claimed in claim 28, wherein the structuring step comprises the steps of:
determining whether the selected emphasis words are applicable to the information type of the generated sentence pattern information;
causing the emphasis words to be tagged to the sentence pattern information in accordance with a result of the determining step or rearranging the emphasis words in accordance with the determined information type; and
structuring the rearranged emphasis words in accordance with meta information corresponding to the information type extracted from the meta DB.

30. The text-to-speech conversion method as claimed in claim 29, wherein layouts for structurally displaying the emphasis words selected in accordance with the information type and additionally displayed contents are stored as the meta information in the meta DB.
